(19) United States
(12) Patent Application Publication
(10) Pub. No.: US 2025/0215355 A1
(43) Pub. Date: Jul. 3, 2025

(54) SYNERGISTIC RUST STAIN REMOVAL COMPOSITIONS AND METHODS OF REMOVING RUST STAIN FROM FABRIC

(71) Applicant: Diversey, Inc., Fort Mill, SC (US)

(72) Inventors: Pramod Sambhaji JAGTAP, Mumbai (IN); Prashant Kumar PANDEY, Mumbai (IN)

(73) Assignee: Diversey, Inc., Fort Mill, SC (US)

(21) Appl. No.: 18/847,992

(22) PCT Filed: Mar. 15, 2023
(86) PCT No.: PCT/IB2023/052535

§ 371 Date: Sep. 17, 2024

(30) Foreign Application Priority Data
Mar. 17, 2022 (IN) 202211014841

(51) Int. Cl. C11D 3/20; C11D 1/14; C11D 3/04; C11D 3/30; C11D 3/43

(52) U.S. Cl. CPC C11D 3/2082; C11D 1/146; C11D 3/042; C11D 3/046; C11D 3/2096; C11D 3/30; C11D 3/43

(57) ABSTRACT

A synergistic rust stain removal composition for fabric comprises an oxalic acid in an amount of more than about 1% by weight but less than about 13% by weight; an ascorbic acid in an amount of more than about 0.5% but less than 7% by weight, all based on total weight of the composition; and water. A method of removing rust stain from fabric comprises contacting the fabric with such synergistic rust stain removal composition. Furthermore, a method of removing rust stain from fabric is disclosed that comprises contacting the fabric with a first aqueous solution comprising from about 0.5% to about 6% by weight of ascorbic acid based on total weight of the first aqueous solution; and contacting the fabric with a second aqueous solution comprising from about 1% to about 12% by weight of oxalic acid based on total weight of the second aqueous solution.

### CROSS-REFERENCE TO RELATED APPLICATION

This application claims priority to Indian Provisional Application No. 202211014841, filed on Mar. 17, 2022.

### TECHNICAL FIELD

This disclosure relates to the synergistic rust removal compositions and the methods of removing rust stain from fabric.

### BACKGROUND

Rust stains on the fabric articles are iron (III) oxide salts. The insolubility of iron (III) oxide salts in water precludes their removal from the fabric articles through routine laundry/fabric washing operation. An additional step is needed in the laundry operations to effectively remove rust stains from the fabric articles. Typically, the rust stained fabric articles are pretreated with a rust stain remover prior to the laundry operation.

Conventional rust stain removers usually include hydrofluoric acid as an active ingredient, such as the WHINK® Rust Stain Remover manufactured by Rust-Oleum Corporation that is an aqueous solution containing hydrofluoric acid at from about 1% to about 3% by weight based on total weight of the solution, or the RustGO® Rust Remover by A. L. Wilson Chemical Company that is an aqueous solution containing hydrofluoric acid at from about 5% to about 10% by weight based on total weight of the solution. Hydrofluoric acid has been known for its effective removal of rust stains from fabric in a short contact time, such as five minutes. However, hydrofluoric acid is extremely hazardous and corrosive that in very small amounts it still causes severe burns when contacted with human skin. Hydrofluoric acid has been documented to penetrate the human skin and degrade underlying bone.

Furthermore, hydrofluoric acid can negatively impact the fabric fibers, resulting in the fabric damage and thereby the shortened service life of the fabric articles.

There is a need for a rust stain removal composition that neither damages the fabric articles nor causes severe burns when contact with human skin, and yet provides at least the same rust removal efficacy as the conventional rust stain removers (e.g., an aqueous solution of hydrofluoric acid).

### SUMMARY

In the first aspect, a synergistic rust stain removal composition is disclosed that comprises an oxalic acid in an amount of more than about 1% by weight but less than 13% by weight based on total weight of the composition; an ascorbic acid in an amount of more than about 0.5% but less than 7% by weight based on total weight of the composition; and water. In some embodiments, the oxalic acid is present in an amount of more than about 6% but less than about 13% by weight based on total weight of the composition. In some embodiments, the oxalic acid is present in an amount of from about 2% to about 12% by weight, preferably from about 3% to about 12% by weight, most preferably from about 7% to about 12% by weight, based on total weight of the composition. In some embodiments, the ascorbic acid is present in an amount of from about 1% to about 6% by weight based on total weight of the composition. In the some embodiments, the synergistic rust stain removal composition comprises an oxalic acid in an amount of from about 7% to about 12% by weight; an ascorbic acid in an amount of from about 1% to about 6% by weight based on total weight of the composition; and water. In some embodiments, the synergistic rust stain removal composition further comprises pH adjusting agent, organic solvent, surfactant, chelating agent, acrylic polymer, oxidizing agent, fragrant, dye, or any combination thereof.

In some embodiments, the synergistic rust stain removal composition consists of the oxalic acid in an amount of more than about 1% by weight but less than about 13% by weight, based on total weight of the composition; the ascorbic acid in an amount of more than about 0.5% but less than about 7% by weight based on total weight of the composition; water; and optionally at least one additive selected from pH adjusting agent, organic solvent, surfactant, chelating agent, acrylic polymer, oxidizing agent, fragrant, dye, or any combination thereof. In certain embodiments, the oxalic acid is present in an amount of from about 2% to about 12% by weight, preferably from about 7% to about 12% by weight, based on total weight of the composition. In certain embodiments, the ascorbic acid in an amount of from about 2% to about 6% by weight based on total weight of the composition.

In some embodiments, the synergistic rust stain removal composition does not comprise hydrogen peroxide, inorganic acid (e.g., hydrofluoric acid, hydrochloric acid, sulfuric acid, nitric acid, phosphoric acid, boric acid, and the like), other organic acids beside oxalic acid and ascorbic acid (e.g., formic acid, acetic acid, fumaric acid, citric acid, malic acid, tartaric acid, ethane-1-hydroxy-1,1′-diphosphonic acid, fatty acid, and the like), fluorine-based salt (e.g., calcium fluoride, sodium fluoride, ammonium bifluoride, and the like), or any combination thereof.

In the second aspect, a method of removing rust stain from fabric is provided that comprises contacting the fabric with the aforementioned synergistic rust stain removal composition. In some embodiments, the fabric is contacted with the rust stain removal composition for a time period of from about 1 minute to about 20 minutes, preferably about 5 minutes. In some embodiments, the contact time of 5 minutes and the method provides the percentage of rust removal of at least 50% as calculated based on the reflectance of the fabric at a wavelength of 460 nanometers. In some embodiments, the contact time of 5 minutes and the change in fluidity values of the fabric between before and after the contact with the rust removal composition is no more than 25% as determined according to the Indian Standard IS 244 (1984) (Second Revision, Reaffirmed 2006).

In the third aspect, a method of removing rust stain from fabric is provided that comprises contacting the fabric with a first aqueous solution comprising from about 0.5% to about 6% by weight of ascorbic acid based on total weight of the first aqueous solution; and contacting the fabric with a second aqueous solution comprising from about 1% to about 12% by weight of oxalic acid based on total weight of the second aqueous solution. In some embodiments, the method comprises contacting the fabric with the first aqueous solution, and then contacting the fabric with the second aqueous solution. In some embodiments, the method comprises contacting the fabric with the second aqueous solution, and then contacting the fabric with the first aqueous solution. In some embodiments, the method comprises contacting the fabric with the first aqueous solution and the second aqueous solution at the same time. The fabric may be contacted with the first aqueous solution and the second aqueous solution for a time period of from about 1 minute to about 20 minutes, preferably about 5 minutes. Furthermore, the fabric may be contacted with the first aqueous solution and the second aqueous solution at room temperature. In some embodiments, the method provides the percentage of rust removal of at least 50% as calculated based on the reflectance of the fabric at a wavelength of 460 nanometers. In some embodiments, the change in fluidity values of the fabric between before and after the contact with the rust removal composition is no more than 25% as determined according to the Indian Standard IS 244 (1984) (Second Revision, Reaffirmed 2006).

Other aspects of the disclosure will become apparent by consideration of the detailed description.

### DESCRIPTION OF THE DRAWING

FIG. 1 is a graph plotting between the amounts of ascorbic acid in the rust removal composition (reported in percentage by weight based on total weight of the rust removal composition) and the rust removal efficacy on fabric (reported as the Reflectance R460 Value).

### DETAILED DESCRIPTION

The present disclosure generally relates to a synergistic rust removal composition that is effective in removing rust stain from surface, especially from fabric, in a relatively short contact time, e.g., a 5-minutes contact time. The disclosed synergistic rust removal composition causes less damage to the fabric and reduces the safety concerns of the user, but yet provides at least the same level of rust stain removal efficacy as the conventional rust stain removers that utilize hydrofluoric acid as an active ingredient. The present disclosure also relates to a method of removing rust stain from fabric that exhibits an unexpected synergistic enhancement in rust removal efficacy.

The terms “comprise(s),” “comprising,” “include(s),” “including,” “having,” “has,” “contain(s),” “containing,” and variants thereof, as used herein, are open-ended transitional phrases, terms, or words that are meant to encompass the items listed thereafter and equivalents thereof as well as additional items. The singular forms “a”, “and”, and “the” include plural references unless the context clearly dictates otherwise. Where the term “comprising” is used, the present disclosure also contemplates other embodiments “comprising”, “consisting of”, or “consisting essentially of” elements presented herein, whether explicitly set forth or not.

Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The modifier “about” used in connection with a quantity is inclusive of the stated value and has the meaning dictated by the context (for example, it includes at least the degree of error associated with the measurement of the particular quantity). The term “about” refers to plus or minus 10% of the indicated number. For example, “about 10%” indicates a range of 9% to 11%, and “about 1” means from 0.9 to 1.1. Other meanings of “about” may be apparent from the context, such as rounding off, so, for example “about 1” also means from 0.5 to 1.4.

The terms “weight percent”, “wt %”, “percent by weight”, “% by weight”, and variations thereof, as used herein, refer to the concentration of a component as the weight of such component divided by the total weight of the composition and multiplied by 100. Unless indicated otherwise, all concentrations are expressed as weight percentage concentrations.

The term “substantially free” refers that the composition does not contain a particular compound, or that a particular compound is not added to the composition intentionally. Should the particular compound be present through contamination, the amount of such particular compound shall be less than 0.5% by weight, preferably less than 0.1% by weight based on total weight of the composition.

The term “fabric” as used herein refers to any woven, non-woven, knitted, felted material, or any combination thereof that is produced from, or in combination with, any natural fibers, regenerated fibers, synthetic fibers, or substitutes therefore. Non-limiting examples of natural fibers are cotton and wool fibers. Non-limiting examples of regenerated fibers are viscose and rayon. Non-limiting examples of synthetic fibers are polyester, polyamide (aka nylon), and polyacrylic fibers.

The term “fiber” as used herein refers to a material that is capable of being spun into a yarn or made into a fabric by bonding or by interlacing in a variety of ways including, but not limited to, weaving, knitting, braiding, felting, twisting, webbing, or any combination thereof.

The term “yarn” as used herein refers to a strand of textile fiber in a form suitable for weaving, knitting, braiding, felting, twisting, webbing or otherwise fabricating into a fabric.

The term “Reflectance R460 value” as used herein refers to the reflectance of the fabric at a wavelength of 460 nanometers.

In the first aspect of present disclosure, a rust stain removal composition comprises:
an oxalic acid in an amount of more than about 1% by weight but less than about 13% by weight, based on total weight of the composition;
an ascorbic acid in an amount of more than about 0.5% but less than 7% by weight based on total weight of the composition; and water.

For oxalic acid, in some embodiments, the oxalic acid is present in an amount of more than about 1%, about 1.5%, about 2%, about 2.5%, about 3%, about 3.5%, about 4%, about 4.5%, about 5%, about 5.5%, about 6%, about 6.25%, about 6.5%, about 6.75%, about 7% or about 7.25% by weight based on total weight of the rust stain removal composition; and/or less than about 7.5%, about 8%, about 8.5%, about 9%, about 9.5%, about 10%, about 10.5%, about 11%, about 11.5%, about 12%, about 12.25%, about 12.5%, about 12.75% or about 13% by weight based on total weight of the rust stain removal composition. In some embodiments, the oxalic acid is present in an amount of more than about 6% but less than about 13% by weight based on total weight of the composition.

In some embodiments, the oxalic acid is present in an amount of from about 2%, about 2.5%, about 3%, about 3.5%, about 4%, about 4.5%, about 5%, about 5.5%, about 6%, about 6.25%, about 6.5%, about 6.75%, about 7% or about 7.25% by weight based on total weight of the rust stain removal composition to about 7.5%, about 8%, about 8.5%, about 9%, about 9.5%, about 10%, about 10.5%, about 11%, about 11.5%, about 12%, about 12.25%, about 12.5% or about 12.75% by weight based on total weight of the rust stain removal composition.

In some embodiments, the oxalic acid is present in an amount of from about 2% to about 12% by weight based on total weight of the rust stain removal composition. In some embodiments, the oxalic acid is present in an amount of from about 3% to about 12% by weight based on total weight of the rust stain removal composition. In some embodiments, the oxalic acid is present in an amount of from about 7% to about 12% by weight based on total weight of the rust stain removal composition.

For ascorbic acid, in some embodiments, the ascorbic acid is present in an amount of more than about 0.5%, about 0.75%, about 1%, about 1.25%, about 1.5%, about 1.75%, about 2%, about 2.25%, about 2.5%, about 2.75% or about 3% by weight based on total weight of the rust stain removal composition; and/or less than about 3.25%, about 3.5%, about 3.75%, about 4%, about 4.25%, about 4.5%, about 4.75%, about 5%, about 5.25%, about 5.75%, about 6%, about 6.25%, about 6.5%, about 6.75% or about 7% by weight based on total weight of the rust stain removal composition.

In some embodiments, the ascorbic acid is present in an amount of from about 0.75%, about 1%, about 1.25%, about 1.5%, about 1.75%, about 2%, about 2.25%, about 2.5%, about 2.75% or about 3% by weight based on total weight of the rust stain removal composition to about 5%, about 5.25%, about 5.75%, about 6%, about 6.25%, about 6.5% or about 6.75% by weight based on total weight of the rust stain removal composition. In some embodiments, the ascorbic acid is present in an amount of from about 1% to about 6% by weight based on total weight of the rust stain removal composition.

In some embodiments, the disclosed rust removal composition comprises from about 7% to about 12% by weight of oxalic acid; from about 1% to about 6% by weight of ascorbic acid; and water, all based on total weight of the rust stain removal composition.

In some embodiments, the disclosed rust removal composition further comprises pH adjusting agent, organic solvent, surfactant, chelating agent, acrylic polymer, oxidizing agent, fragrance, dye, or any combination thereof. Non-limiting examples of suitable pH adjusting agents are sulfamic acid, ethanolamine, sodium bisulfite, and the like. Nonlimiting examples of organic solvents are glycol ethers, alcohol, ethylene glycol, and the like.

When desired, the surfactant may comprise anionic surfactant, non-ionic surfactant, or any combination thereof. Non-limiting examples of anionic surfactants are sodium lauryl sulfate, sodium alkyl benzene sulfonate, and the like.

In certain embodiments, the disclosed rust removal composition consists of: the oxalic acid in an amount of more than about 1% but less than about 13% by weight based on total weight of the composition;
the ascorbic acid in an amount of more than about 0.5% but less than 7% by weight based on total weight of the composition;
   water; and
optionally at least one additive selected from pH adjusting agent, organic solvent, surfactant, chelating agent, acrylic polymer, oxidizing agent, fragrance, dye, or any combination thereof.

In some embodiments, the disclosed rust removal composition does not comprise hydrogen peroxide, inorganic acid, other organic acid beside oxalic acid and ascorbic acid, fluorine-based salt, or any combination thereof. Non-limiting examples of such inorganic acids are hydrochloric acid, sulfuric acid, nitric acid, phosphoric acid, boric acid, and the like. Non-limiting examples of such other organic acid are formic acid, acetic acid, fumaric acid, citric acid, malic acid, tartaric acid, ethane-1-hydroxy-1,1′-diphosphonic acid (HEDP), fatty acid, and the like. Non-limiting examples of such fluorine-based salts are calcium fluoride, sodium fluoride, ammonium bifluoride, and the like.

In the second aspect of present disclosure, a method of removing rust stain from fabric comprises contacting the fabric with the aforementioned rust removal composition. The contact time between the fabric and the disclosed rust removal composition may be from about 1 minute to about 20 minutes. In some embodiments, the contact time is about 5 minutes. Furthermore, the fabric may be contacted with the first aqueous solution and the second aqueous solution at room temperature.

The efficacy of the rust removal composition in removing the rust stain from fabric may be determined based on the reflectance of fabric at a wavelength of 460 nanometers (hereinafter “Reflectance R460 value”). The higher the Reflectance R460 value indicates the higher level of the fabric whiteness, and thereby the superior efficacy of the rust removal composition in removing the rust stain from fabric. Furthermore, the percentage rust removal may be quantified based on the Reflectance R460 values of the fabric using the following equation:

% Rust Removal=RV_{T}×100/RV_{R}
wherein
RV_{T} was the Reflectance R460 value of the rust stained fabric swatches after the treatment with the rust removal composition, and
RV_{R} was the Reflectance R460 value of the clean fabric swatches that does not need any treatment with the rust removal composition.

In some embodiments, the contact time between the fabric and the rust removal composition is 5 minutes, and the disclosed method provides the percentage of rust removal of at least about 50% as calculated based on the reflectance of the fabric at a wavelength of 460 nanometers.

The level of fabric damage due to treatment with the rust removal composition may be determined based on the change in fluidity value of the fabric before and after the treatment. The fluidity value of the fabric is measured according to the Indian Standard IS 244 (1984): Method for determination of viscosity (or fluidity) of solutions of cotton and regenerated cellulosic man-made fibers in cuprammonium hydroxide (Second Revision, Reaffirmed 2006), which is incorporated herein by reference (hereinafter “the Indian Standard IS 244 Method”). According to the Indian Standard IS 244 Method, the fluidity value of fabric linearly correlates to the percentage loss of fabric tensile strength resulted from a chemical action (e.g., a treatment with rust removal composition). Therefore, the level of fabric damage due to the rust removal treatment may be quantified based on the percentage change in the fluidity values of fabric before and after the treatment as shown in the following equation:

% Change in Fluidity Value=(FV_{T}−FV_{R})×100/FV_{R}
wherein
FV_{T} was the fluidity value of the rust stained fabric swatches after the treatment with rust removal composition, and
FV_{R} was the fluidity value of the rust stained fabric swatches before the treatment with rust removal composition.

The higher % change in the fluidity values of fabric measured according to the Indian Standard IS 244 Method, indicates the higher level of fabric damage caused by the rust removal treatment.

In some embodiments, the contact time between the fabric and the rust removal composition in the disclosed method is 5 minutes, and the change in fluidity values of the fabric between before and after the contact is no more than about 25% as determined according to the Indian Standard IS 244 Method.

In some embodiments, the contact time between the fabric and the rust removal composition is 5 minutes, the disclosed method provides the percentage of rust removal of at least 50% as calculated based on the reflectance of the fabric at a wavelength of 460 nanometers, and the change in fluidity values of the fabric between before and after the contact is no more than 25% as determined according to the Indian Standard IS 244 Method.

The disclosed rust removal composition provides the unexpected synergistic effect between oxalic acid and ascorbic acid in removing rust stain from fabric even a relatively short contact time, e.g., a contact time between the fabric and the rust removal composition of about 5 minutes. The synergistic effect may be achieved when the amount of oxalic acid in the rust removal composition is more than 1% by weight but less than 13% by weight based on total weight of the composition. As a non-limiting example shown in EXAMPLE 1 and TABLE 1A of the EXAMPLES section, the unexpected synergistic effect is achieved when the amount of oxalic acid in the rust removal composition is from about 2% to about 12% by weight based on total weight of the composition.

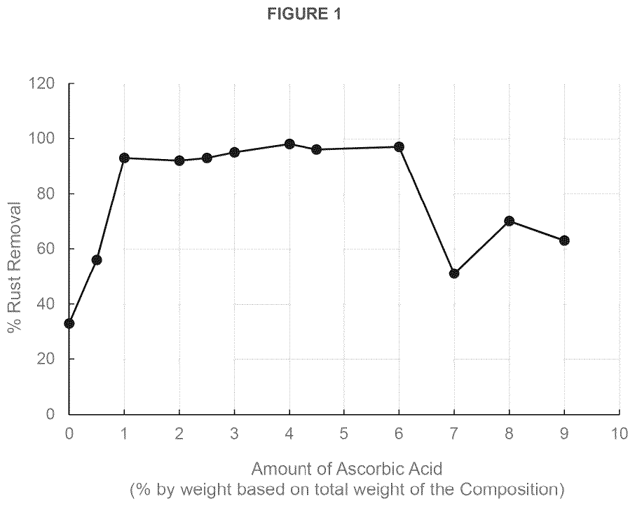

Furthermore, surprisingly and unexpectedly, a substantial enhancement in the rust removal efficacy is achieved when the amount of ascorbic acid in the rust removal composition (when used in combination with oxalic acid) is more than 0.5% by weight but less than 7% by weight based on total weight of the composition. As a non-limiting example shown in FIG. 1, the unexpected and substantial enhancement in the % rust removal is achieved when the amount of ascorbic acid in the rust removal composition (when used in combination with oxalic acid) is from about 1% to about 6% by weight based on total weight of the composition. See also EXAMPLE 3 and TABLE 3A. This finding is further unexpected because ascorbic acid by itself (i.e., when used as the sole active ingredient for rust removal) shows extremely poor rust removal efficacy, and its rust removal efficacy remains at only about 8% to 9% even when the amount of ascorbic acid is increased from 0.5% to 7% by weight based on total weight of the composition. See EXAMPLE 2 and TABLE 2.

The disclosed rust removal composition may provide at least the same level rust removal efficacy as the known rust stain removers such as the RustGO® rust remover commercially available from A. L. Wilson Chemical Company, NJ (USA) that contains hydrofluoric acid as the active ingredient at 10% by weight based on total weight the rust remover (“10% Hydrofluoric Acid Solution”), and the alternative commercially available rust remover for fabric that contains oxalic acid as the active ingredient at 10% by weight based on total weight the rust remover (“10% Oxalic Acid Solution”). As a non-limiting example shown in TABLE 5, the 10% Hydrofluoric Acid Solution provides the % rust removal of 98%, while the 10% Oxalic Acid Solution provides the % rust removal of only 47%. The disclosed rust removal composition can provide the % rust removal as high as 95%, which is about the same level of rust removal efficacy achieved with the conventional and widely used 10% Hydrofluoric Acid Solution.

While the conventional rust removal compositions (e.g., 10% Hydrofluoric Acid Solution) are safe when their use directions are followed, hydrofluoric acid can still cause severe and penetrating burns when contacted with the human skin. Burns caused by hydrofluoric acid are typically not noticed until the day following contact when they show as painful sores on the skin.

The disclosed rust removal composition reduces the potentially harmful effects associated with the conventional rust removal composition that utilizes hydrofluoric acid as an active ingredient. The disclosed rust removal composition utilizes a mixture of oxalic acid and ascorbic acid, and not hydrofluoric acid; therefore, the potentially harmful effects caused by hydrofluoric acid are reduced.

Moreover, the conventional rust removal compositions (e.g., 10% Hydrofluoric Acid Solution) cause fabric damage, and thereby shortening the service life of the fabric. As non-limiting examples shown in TABLE 1C and TABLE 3B of the EXAMPLES section, the % change in fluidity values of the stained fabric after being treated with conventional rust removal composition (10% Hydrofluoric Acid Solution) is 44%; while the % change in fluidity values of 28% is obtained after the stained fabric is treated with the 10% Oxalic Acid Solution. Thus, the 10% Oxalic Acid Solution causes lower level of fabric damages compared to the 10% Hydrofluoric Acid Solution. But as discussed above, the 10% Oxalic Acid Solution provides much inferior rust removal efficacy to the 10% Hydrofluoric Acid Solution.

The disclosed rust removal composition causes a substantially lower level of fabric damages compared to the 10% Hydrofluoric Acid Solution, and even lower level of fabric damages compared to the 10% Oxalic Acid Solution. As non-limiting examples shown in TABLE 1C and TABLE 3B, the % change in fluidity values of the stained fabric after being treated with the disclosed rust removal composition is lower than 25%, and can even be less than 10%. Nonetheless, the disclosed rust removal composition provides substantially the same level of rust removal efficacy as the 10% Hydrofluoric Acid Solution, and far superior to the 10% Oxalic Acid Solution. See TABLE 5.

Therefore, the disclosed rust stain removal composition provides at least the same level of rust removal efficacy as the conventional rust stain removers (e.g., an aqueous solution of 10 wt % hydrofluoric acid), and yet it causes a substantially lower level of fabric damage compared to the conventional rust stain removers. Moreover, the disclosed rust removal composition reduces the potentially harmful effects associated with the conventional rust removal compositions that utilize hydrofluoric acid as an active ingredient.

In the third aspect of present disclosure, a method of removing rust stain from fabric comprises:
contacting the fabric with a first aqueous solution comprising from about 0.5% to about 6% by weight of ascorbic acid based on total weight of the first aqueous solution; and
contacting the fabric with a second aqueous solution comprising from about 1% to about 12% by weight of oxalic acid based on total weight of the second aqueous solution.

In some embodiments, the method comprises contacting the fabric with the first aqueous solution, and then contacting the fabric with the second aqueous solution.

In some embodiments, the method comprises contacting the fabric with the second aqueous solution, and then contacting the fabric with the first aqueous solution.

In some embodiments, the method comprises contacting the fabric with the first aqueous solution and the second aqueous solution simultaneously.

In some embodiments, the first aqueous solution comprises the ascorbic acid in an amount of at least about 0.5%, about 1.0%, about 1.5%, about 2%, about 2.5%, about 3% or about 3.5% by weight based on total weight of the first aqueous solution; and/or no more than about 4%, about 4.5%, about 5.0%, about 5.5% or about 6.0% by weight based on total weight of the first aqueous solution. In some embodiments, the first aqueous solution comprises the ascorbic acid in an amount of from about 0.5%, about 1.0%, about 1.5%, about 2%, about 2.5%, about 3% or about 3.5% by weight based on total weight of the first aqueous solution to about 4%, about 4.5%, about 5.0%, about 5.5% or about 6.0% by weight based on total weight of the first aqueous solution.

In some embodiments, the second aqueous solution comprises the oxalic acid in an amount of at least about 1%, about 2%, about 3%, about 4%, about 5%, about 6% or about 7% by weight based on total weight of the second aqueous solution; and/or no more than about 8%, about 9%, about 10%, about 11% or about 12% by weight based on total weight of the second aqueous solution. In some embodiments, the second aqueous solution comprises the oxalic acid in an amount of from about 1%, about 2%, about 3%, about 4%, about 5%, about 6% or about 7% by weight based on total weight of the second aqueous solution to about 8%, about 9%, about 10%, about 11% or about 12% by weight based on total weight of the second aqueous solution.

In some embodiments, the first aqueous solution comprises the ascorbic acid in an amount of from about 1% to 6% by weight based on total weight of the first aqueous solution; and/or the oxalic acid in an amount of from about 6% to about 12% by weight based on total weight of the second aqueous solution.

In the disclosed method of the third aspect, the fabric may be contacted with the first aqueous solution and the second aqueous solution for a time period of from about 1 minute to about 20 minutes. In some embodiments, the fabric is contacted with the first aqueous solution and the second aqueous solution for about 5 minutes. Furthermore, the fabric may be contacted with the first aqueous solution and the second aqueous solution at room temperature.

In some embodiments, the contact time between the fabric and the rust removal composition is 5 minutes, and the disclosed method provides the percentage of rust removal of at least about 50% as calculated based on the reflectance of the fabric at a wavelength of 460 nanometers.

In some embodiments, the contact time between the fabric and the rust removal composition in the disclosed method is 5 minutes, and the change in fluidity values of the fabric between before and after the contact is no more than about 25% as determined according to the Indian Standard IS 244 Method.

In some embodiments, the contact time between the fabric and the rust removal composition is 5 minutes, the disclosed method provides the percentage of rust removal of at least 50% as calculated based on the reflectance of the fabric at a wavelength of 460 nanometers, and the change in fluidity values of the fabric between before and after the contact is no more than 25% as determined according to the Indian Standard IS 244 Method.

The disclosed method of removing rust stain from fabric provides at least the same rust removal efficacy as the conventional rust removal composition (10% Hydrofluoric Acid Solution). As a non-limiting example shown in EXAMPLE 7 and TABLE 7A, the 10% Hydrofluoric Acid Solution provides the % rust removal of about 98%, while the disclosed rust removal composition provides the % rust removal of about 100%.

Furthermore, the disclosed rust removal composition causes a substantially lower level of fabric damages compared to the 10% Hydrofluoric Acid Solution. See TABLE 7B.

Therefore, the disclosed method of removing rust stain from fabric provides at least the same level of rust removal efficacy as the conventional rust stain removers (e.g., an aqueous solution of 10 wt % hydrofluoric acid), and yet it causes a substantially lower level of fabric damage compared to the conventional rust stain removers. Moreover, the disclosed rust removal composition reduces the potentially harmful effects associated with the conventional rust removal compositions that utilize hydrofluoric acid as an active ingredient.

The following non-limiting examples illustrate the compositions of the present disclosure and methods of use thereof.

### EXAMPLES

### Materials and Procedures

The fabric used was WFK 11 A fabric, which was made of 100% cotton, plain waved and free of any optical brightener. The fabric had a mass of 170 g/m², a warp and weft of 25 threads per centimeter, and a fluidity value of less than 50 Pa·s. The WKF fabric was measured for the reflectance at the wavelength of 460 nm (“Reflectance R460 value”) and the fluidity value.

The WKF fabric having a dimension of 20 cm×20 cm was placed on a plastic tray. Then, about 100 ml of 10% solution of FeSO₄·7H₂O solution was poured into the plastic tray. After 5 minutes of contact, the fabric was removed from the tray and air dried for three hours. The dried fabric was then soaked in 100 ml of 10% FeSO₄·7H₂O solution again for five minutes, removed, and followed by air drying for about 3 to 4 hours. The resulting fabric was cut into smaller pieces (“fabric swatches”) having a dimension of 5 cm×5 cm.

About 500 ml of 10% solution (v/v) of ammonium hydroxide was prepared in a beaker. Each fabric swatch was dipped into the ammonium hydroxide solution for 20 seconds, without touching the sides of beaker. The color of fabric swatches was green due to the formation of Fe(NH₄)₂(SO₄)₂, which was a Fe²⁺ complex. After 20 seconds of contact, the fabric swatches was removed from the ammonium hydroxide solution and allowed for air drying, wherein the Fe²⁺ ion on the fabric swatches was slowly oxidized to Fe³⁺ ion and the color of fabric swatches slowly turned into muddy brown color of rust stain (a Fe³⁺ complex). After 24 hours of air drying, the fabric swatches were washed in clean tap water to remove any traces of alkali. After the fabric swatches were dried, the rust stained fabric swatches were measured for the Reflectance R460 value and the fluidity value as reported as the Reflectance R460 value and the fluidity value before treatment with the tested rust removal compositions.

### One-Step Rust Removal Treatment

The stained fabric swatches were treated with the tested rust removal composition by applying the tested rust removal composition onto the stained fabric swatches via a spray application, in an amount sufficient to wet the stained fabric swatches. The stained fabric swatches were allowed to contact with the tested rust removal composition for 5 minutes, and then rinsed with water or subjected to regular laundering process. The resulting treated fabric swatches were measured for the Reflectance R460 value and the fluidity value.

### Two-Step Rust Removal Treatment

In the first step, the stained fabric swatches were treated with the first composition via a spray application. The contact with the first composition was allowed for about 5 seconds or immediate application of second step. Then, in the second step, the fabric swatches were contacted with the second composition for 5 minutes. Thereafter, the treated fabric swatches were rinsed with water or subjected to regular laundering process. The Reflectance R460 value and the fluidity value of the resulting treated fabric swatches were measured.

Determination of Rust Removal Efficacy based on the Reflectance R460 Value

The efficacy of tested rust removal composition in removing rust from the fabric swatches was determined based on the reflectance of treated fabric swatch at a wavelength of 460 nm (“Reflectance R460 value”) using the CM-3600d bench-top spectrophotometer available from Konica Minolta Sensing Americas, Inc. The higher the Reflectance R460 value indicated the higher level of the fabric whiteness, and thereby the superior efficacy of the tested composition in removing rust from the fabric. The cleaned fabric swatches showed the Reflectance R460 value of about 80±3.

The percentage rust removal was calculated based on the Reflectance R460 values of the fabric as shown below:

$$\% Rust Removal = \frac{{RV}_{T} \times 100}{{RV}_{R}}$$

wherein
RV_{T} was the Reflectance R460 value of the rust stained fabric swatches after the treatment with rust removal composition, and
RV_{R} was the Reflectance R460 value of the clean fabric swatches that did not need the rust removal treatment. The RV_{R} value used in the calculated was 81, which was the average Reflectance R460 values of the clean fabric swatches that did not need the rust removal treatment.

### Determination of Fabric Damage Level Based on the Fluidity Value

The level of fabric damage due to treatment with the tested rust removal composition was determined based on the fluidity value of the treated fabric. The fluidity value of fabric was determined according to the Indian Standard IS 244 (1984): Method for determination of viscosity (or fluidity) of solutions of cotton and regenerated cellulosic manmade fibers in cuprammonium hydroxide (Second Revision, Reaffirmed 2006), which is incorporated herein by reference. The higher the fluidity value of fabric measured according to the Indian Standard IS 244 Method, indicated the higher percentage loss of fabric tensile strength resulted from a treatment with the tested rust removal composition.

According to the Indian Standard IS 244 Method, the fluidity value was reciprocal of viscosity of the cuprammonium hydroxide solution of treated fabric, and reported in a unit of poise⁻¹. A weighed sample of the treated fabric swatch was dissolved in a cuprammonium hydroxide solution in a viscometer to provide a fabric solution. The temperature of viscometer and its contents was brought to 20±1° C. in the thermostat. The fabric solution was allowed to flow from the viscometer through the capillary. The time taken by the meniscus of the fabric solution to fall from one fixed mark to another fixed mark was reported, and then the fluidity was determined according to the Indian Standard IS 244 Method.

The level of fabric damage due to the rust removal treatment was quantified based on the percentage change in the fluidity values of fabric before and after the treatment as shown in the following equation:

$$\% Change in Fluidity Value = \frac{( F {V}_{T} - F {V}_{R} ) \times 100}{{FV}_{R}}$$

wherein
FV_{T} was the fluidity value of the rust stained fabric swatches after the treatment with rust removal composition, and
FV_{R} was the fluidity value of the rust stained fabric swatches before the treatment with rust removal composition.

### Example 1

Rust stained fabric swatches were treated with the tested rust removal composition in a one-step rust removal treatment for 5 minutes. The efficacy of tested rust removal composition in removing rust from the stained fabric swatches was determined based on the Reflectance R460 value.

TABLE 1A

| | #1A | #1B | #1C | #1A | #1D | #1E | #1A | #1F | #1G | #1A | #1H | #1J | #1K |
|---|---|---|---|---|---|---|---|---|---|---|---|---|---|
| Oxalic Acid | — | 1% | 1% | — | 2% | 2% | — | 7% | 7% | — | 12% | 12% | 13% |
| Ascorbic Acid | 3% | — | 3% | 3% | — | 3% | 3% | — | 3% | 3% | — | 3% | 3% |
| Sulfamic Acid | 3% | — | 3% | 3% | — | 3% | 3% | — | 3% | 3% | — | 3% | 3% |
| Ethanolamine | 2% | — | 2% | 2% | — | 2% | 2% | — | 2% | 2% | — | 2% | 2% |
| Surfactant | 1% | — | 1% | 1% | — | 1% | 1% | — | 1% | 1% | — | 1% | 1% |
| Organic Solvent | 3% | — | 3% | 3% | — | 3% | 3% | — | 3% | 3% | — | 3% | 3% |
| Water (q.s. to 100%) | | | | | | | | | | | | | |
| Averaged | 8.23 | 9.43 | 18.47 | 8.23 | 14.19 | 28.76 | 8.23 | 26.91 | 77.17 | 8.23 | 36.80 | 74.96 | *** |
| Reflectance R460 Value | | | | | | | | | | | | | |
| % Rust Removal | 10% | 12% | 23% | 10% | 18% | 36% | 10% | 33% | 95% | 10% | 45% | 93% | |

***The tested rust removal composition #1K was not stable and precipitated.

TABLE 1A showed the Reflectance R460 values of the fabric swatches after treatment with the tested rust removal compositions.

Tested Composition #1A contained ascorbic acid as a sole active ingredient tor rust removal, along with sulfamic acid, ethanolamine, sodium lauryl sulfate surfactant, glycol ether as an organic solvent, and the balance of water. The stained fabric swatches treated with the tested composition #1A showed the averaged Reflectance R460 value of 8.23, which corresponded to about 10% rust removal.

Tested Composition #1B was an aqueous solution of oxalic acid at 1% by weight based on total weight of the solution, and contained oxalic acid as a sole active ingredient for rust removal. The stained fabric swatches treated with the tested composition #1B showed the averaged Reflectance R460 value of 9.43, which corresponded to about 12% rust removal.

Tested Composition #1C was essentially the combination of the tested compositions #1A and #1B, and contained both ascorbic acid and oxalic acid as the active ingredients for rust removal. The stained fabric swatches treated with the tested composition #1B showed the averaged Reflectance R460 value of 18.47, which corresponded to about 23% rust removal.

Tested Composition #1C provided about 23% rust removal, which was about the additive value of 10% rust removal from Tested Composition #1A (ascorbic acid as a sole active ingredient for rust removal) and 12% rust removal from Tested Composition #1B (oxalic acid as a sole active ingredient for rust removal). Therefore, at the oxalic acid concentration of 1% by weight based on total weight of the tested rust removal composition, no synergistic effect on the rust removal efficacy was observed between ascorbic acid and oxalic acid.

Tested Composition #1D was an aqueous solution that contained oxalic acid as an active ingredient for rust removal at 2% by weight based on total weight of the solution. The stained fabric swatches treated with the tested composition #1D showed the averaged Reflectance R460 value of 14.19, which corresponded to about 18% rust removal.

Tested Composition #1E was essentially the combination of the tested compositions #1A and #1D, and contained both ascorbic acid and oxalic acid as the active ingredients for rust removal. The stained fabric swatches treated with the tested composition #1E showed the averaged Reflectance R460 value of 28.76, which corresponded to about 36% rust removal.

If the rust removal effect between oxalic acid and ascorbic acid was merely an additive effect, the expected % rust removal of Tested Composition #1E would be about 28%, which was the additive value of about 10% rust removal from Tested Composition #1A and about 18% rust removal from Tested Composition #1D. However, Tested Composition #1E provided the rust removal of about 36%, which was larger than the additive rust removal of 28%. Therefore, at the oxalic acid concentration of 2% by weight based on total weight of the tested rust removal composition, there was a synergistic effect between ascorbic acid and oxalic acid on the rust removal efficacy.

Tested Composition #1F was an aqueous solution that contained oxalic acid as an active ingredient for rust removal at 7% by weight based on total weight of the solution. The stained fabric swatches treated with the tested composition #1D showed the averaged Reflectance R460 value of 26.91, which corresponded to about 33% rust removal.

Tested Composition #1G was essentially the combination of the tested compositions #1A and #1F, and contained both ascorbic acid and oxalic acid as the active ingredients for rust removal. The stained fabric swatches treated with the tested composition #1G showed the averaged Reflectance R460 value of 77.17, which corresponded to about 95% rust removal.

The rust removal of about 95% obtained by the Tested Composition #1G was more than two times higher than the additive rust removal of about 43% (the additive value of about 10% rust removal from Tested Composition #1A and about 33% rust removal from Tested Composition #1F). Therefore, at the oxalic acid concentration of 7% by weight based on total weight of the tested rust removal composition, there was a synergistic effect between ascorbic acid and oxalic acid on the rust removal efficacy.

Tested Composition #1H was an aqueous solution that contained oxalic acid as an active ingredient for rust removal at 12% by weight based on total weight of the solution. The stained fabric swatches treated with the tested composition #1H showed the averaged Reflectance R460 value of 36.80, which corresponded to about 45% rust removal.

Tested Composition #1J was essentially the combination of the tested compositions #1A and #1H, and contained both ascorbic acid and oxalic acid as the active ingredients for rust removal. The stained fabric swatches treated with the tested composition #1J showed the averaged Reflectance R460 value of 74.96, which corresponded to about 93% rust removal.

The rust removal of about 93% obtained by the Tested Composition #1J was more than the additive rust removal of about 55% (the additive value of about 10% rust removal from Tested Composition #1A and about 45% rust removal from Tested Composition #1H). Therefore, at the oxalic acid concentration of 12% by weight based on total weight of the tested rust removal composition, there was a synergistic effect between ascorbic acid and oxalic acid on the rust removal efficacy.

As shown in Tested Composition #1K of TABLE 1A, when the concentration of oxalic acid was about 13% by weight, the tested composition was not stable and precipitated.

TABLE 1B showed the comparative rust removal efficacies of the tested rust removal compositions. Reference was the clean fabric swatches that did not need the rust removal treatment. Two known rust removal compositions were used for the comparative study: the RustGO® rust remover commercially available from A. L. Wilson Chemical Company. NJ (USA), which was widely used and considered as the conventional rust remover for fabric, contained hydrofluoric acid as the active ingredient at 10% by weight based on total weight the rust remover (hereinafter “10% Hydrofluoric Acid Solution”); and an alternative commercially available rust remover for fabric contained oxalic acid as the active ingredient at 10% by weight based on total weight the rust remover (hereinafter “10% Oxalic Acid Solution”).

TABLE 1B

| | Averaged | |
|---|---|---|
| | Reflectance | |
| | R460 Value | |
| | of Treated | |
| | Fabric | % Rust |
| Rust Removal Composition | Swatches | Removal |
| Reference (the clean fabric | 81 | N/A |
| swatches that did not need | | |
| any rust removal treatment) | | |
| 10% Hydrofluoric Acid Solution | 79 | 98% |
| 10% Oxalic Acid Solution | 38 | 47% |
| Tested Composition #1G | 77.17 | 95% |
| (7 wt % oxalic acid) | | |
| Tested Composition #1J | 74.96 | 93% |
| (12 wt % oxalic acid) | | |

Reference, which was the clean fabric swatches that did not need the rust removal treatment, showed the averaged Reflectance R460 value of 81. It was desirable that the fabric swatches after rust removal treatment had the Reflectance R460 value as close to 81 as possible. The treated fabric swatches having the averaged Reflectance R460 value of 81 indicated that the rust stains on the fabric swatches were 100% removed after the treatment (i.e., 100% rust removal).

As shown in TABLE 1B, the conventional 10% Hydrofluoric Acid Solution provided about 98% rust removal; whereas, the 10% Oxalic Acid Solution showed only about 47% rust removal. Tested Compositions #1G (7 wt % oxalic acid) and #1J (12 wt % oxalic acid) provided about 95% and 93% rust removal, respectively.

TABLE 1C showed the fluidity values of the fabric swatches after treatment with the tested rust removal compositions. Reference was the rust stained fabric swatches without any rust removal treatment. Two known rust removal compositions were used for the comparative study: the RustGO® rust remover commercially available from A. L. Wilson Chemical Company, NJ (USA), which was widely used and considered as the traditional rust remover for fabric, contained hydrofluoric acid as the active ingredient at 10% by weight based on total weight the rust remover (hereinafter “10% Hydrofluoric Acid Solution”); and an alternative commercially available rust remover for fabric contained oxalic acid as the active ingredient at 10% by weight based on total weight the rust remover (hereinafter “10% Oxalic Acid Solution”).

TABLE 1C

| | Fluidity | |
|---|---|---|
| | Value of the | |
| | Treated Fabric | |
| | Swatches | % Change in |
| Rust Removal Composition | (Poise⁻¹) | Fluidity Value |
| Reference (without any rust | 9.0 | N/A |
| removal treatment) | | |
| 10% Hydrofluoric Acid Solution | 13.0 | 44% |
| 10% Oxalic Acid Solution | 11.5 | 28% |
| Tested Composition #1E | 9.2 | 2% |
| (2 wt % oxalic acid) | | |
| Tested Composition #1G | 9.5 | 6% |
| (7 wt % oxalic acid) | | |
| Tested Composition #1J | 11.2 | 24% |
| (12 wt % oxalic acid) | | |

Reference, which was the rust stained fabric swatches without any rust removal treatment, showed the fluidity value of 9.0 poise⁻¹. The higher the fluidity value of fabric swatches indicated the higher percentage loss of fabric tensile strength due to the rust removal treatment. The higher % change in fluidity value indicated the higher level of undesirable fabric damages due the rust removal treatment.

As shown in TABLE 1C, upon using the conventional 10% Hydrofluoric Acid Solution as the rust removal composition, the treated fabric swatches showed about 44% lost in fluidity value. Upon using the 10% Oxalic Acid Solution as the rust removal composition, the treated fabric swatches showed about 28% lost in fluidity value. On the other hand, Tested Compositions #1E and #1G provided the lost in fluidity value of only 2% and 6%, respectively. Tested Composition #1J provided the lost in fluidity value of 24%, which was about half of the lost obtained by the conventional 10% Hydrofluoric Acid Solution and still lower than the lost obtained by the 10% Oxalic Acid Solution.

### Example 2

Rust stained fabric swatches having the Reflectance R460 value of about 5±1 were used in the study. The stained fabric swatches were treated with the tested rust removal composition in a one-step rust removal treatment for 5 minutes. The efficacy of tested rust removal composition in removing rust from the stained fabric swatches was determined based on the Reflectance R460 value.

TABLE 2 showed the Reflectance R460 values of the fabric swatches after treatment with the tested rust removal compositions containing ascorbic acid as the sole active ingredient for rust removal. Tested Compositions #2A to #2E were the aqueous solutions containing different concentrations of ascorbic acid, ranging from about 0.5% by weight of ascorbic acid for Tested Composition #2A to about 7% by weight of ascorbic acid for Tested Composition #2E.

TABLE 2

| | #2A | #2B | #2C | #2D | #2E |
|---|---|---|---|---|---|
| Ascorbic Acid | 0.5% | 1% | 3% | 6% | 7% |
| Water (q.s. to 100%) | | | | | |
| Averaged Reflectance R460 Value | 6.28 | 7.00 | 6.25 | 6.99 | 6.66 |
| % Rust Removal | 8% | 9% | 8% | 9% | 8% |

As shown in TABLE 2, the averaged Reflectance R460 values of the treated fabric swatches were about the same regardless the amount of ascorbic acid (wt %) in Tested Compositions #2A to #2E. Thus, the amount of ascorbic acid in the tested rust removal compositions had minimal impact, if any at all, on the rust removal efficacy on the stained fabric.

Furthermore, the averaged Reflectance R460 values of the stained fabric swatches after treatment with the tested rust removal compositions were about the same as the averaged Reflectance R460 value of the stained fabric swatches before the treatment. This indicated that ascorbic acid by itself provided extremely poor rust removal efficacy on the stained fabric.

### Example 3

TABLE 3A showed the Reflectance R460 values of the rust stained fabric swatches after treatment with the tested rust removal compositions in a one-step rust removal treatment. The tested rust removal compositions contained different concentrations of ascorbic acid. Tested Composition #3A contained oxalic acid as the sole active ingredient for rust removal. Tested Compositions #3B to #3N contained both oxalic acid and ascorbic acid as the active ingredients for rust removal, but at difference concentrations of ascorbic acid. The concentrations of ascorbic acid in the test compositions ranged from about 0.5% by weight for Tested Composition #3B to about 9% by weight for Tested Composition #3N.

TABLE 3A

| | #3A | #3B | #3C | #3D | #3E | #3F | #3G | #3H | #3J | #3K | #3L | #3M | #3N |
|---|---|---|---|---|---|---|---|---|---|---|---|---|---|
| Oxalic Acid | 7% | 7% | 7% | 7% | 7% | 7% | 7% | 7% | 7% | 7% | 7% | 7% | 7% |
| Ascorbic Acid | — | 0.5% | 1.0% | 2.0% | 2.5% | 3.0% | 3.5% | 4.0% | 4.5% | 6.0% | 7.0% | 8.0% | 9.0% |
| Sulfamic Acid | 3% | 3% | 3% | 3% | 3% | 3% | 3% | 3% | 3% | 3% | 3% | 3% | 3% |
| Ethanolamine | 2% | 2% | 2% | 2% | 2% | 2% | 2% | 2% | 2% | 2% | 2% | 2% | 2% |
| Surfactant | 1% | 1% | 1% | 1% | 1% | 1% | 1% | 1% | 1% | 1% | 1% | 1% | 1% |
| Organic Solvent | 3% | 3% | 3% | 3% | 3% | 3% | 3% | 3% | 3% | 3% | 3% | 3% | 3% |
| Water (q.s. to 100%) | | | | | | | | | | | | | |
| Reflectance R460 Value | 26.91 | 45.64 | 75.30 | 74.80 | 75.66 | 77.17 | 79.42 | 77.67 | 78.25 | 78.69 | 41.25 | 56.66 | 51.11 |
| % Rust Removal | 33% | 56% | 93% | 92% | 93% | 95% | 98% | 96% | 97% | 97% | 51% | 70% | 63% |

FIG. 1 was a graph plotted between the % rust removal and the amount of ascorbic acid (by weight based on total weight of the tested rust removal composition). Surprisingly and unexpectedly, the significant enhancement in the % rust removal was observed when the amount of ascorbic acid was higher than 0.5% by weight but less than 7% by weight based on total weight of the tested rust removal compositions, such as the amount of ascorbic acid was in an amount of from about 1% to about 6% by weight based on total weight of the tested rust removal composition. Therefore, there was a certain specific concentration range of ascorbic acid in the tested rust removal compositions that unexpectedly provided a substantial enhancement in the % rust removal on the stained fabric swatches.

TABLE 3B showed the fluidity values of the fabric swatches after treatment with the tested rust removal compositions.

TABLE 3B

| | Fluidity | |
|---|---|---|
| | Value of the | |
| | Treated Fabric | % Change in |
| | Swatches | Fluidity |
| Rust Removal Composition | (Poise⁻¹) | Value |
| Reference (without any | 9.0 | N/A |
| rust removal treatment) | | |
| 10% Hydrofluoric Acid Solution | 13.0 | 44% |
| 10% Oxalic Acid Solution | 11.5 | 28% |
| Tested Composition #3B | 9.1 | 1% |
| (0.5 wt % ascorbic acid) | | |
| Tested Composition #3F | 9.5 | 6% |
| (3 wt % ascorbic acid) | | |
| Tested Composition #3L | 10.7 | 19% |
| (7 wt % oxalic acid) | | |

As shown in TABLE 3B, upon using the conventional 10% Hydrofluoric Acid Solution as the rust removal composition, the treated fabric swatches showed about 44% lost in fluidity value. Upon using the 10% Oxalic Acid Solution as the rust removal composition, the treated fabric swatches showed about 28% lost in fluidity value. On the other hand, Tested Compositions #3B, #3F and #3L provided the lost in fluidity value of only 1%, 6% and 19%, respectively.

### Example 4

TABLE 4 showed the averaged Reflectance R460 values of the rust stained fabric swatches after treatment with the tested rust removal compositions in a one-step rust removal treatment. The tested rust removal compositions contained different concentrations of sulfamic acid. Tested Composition #4A contained no sulfamic acid. Tested Compositions #4B to #4E contained sulfamic acid at difference concentrations, ranging from about 0.5% by weight for Tested Composition #4B to about 3% by weight for Tested Composition #4E.

TABLE 4

| | #4A | #4B | #4C | #4D | #4E |
|---|---|---|---|---|---|
| Oxalic Acid | 7% | 7% | 7% | 7% | 7% |
| Ascorbic Acid | 3% | 3% | 3% | 3% | 3% |
| Sulfamic Acid | — | 0.5% | 1% | 2% | 3% |
| Ethanolamine | 2% | 2% | 2% | 2% | 2% |
| Surfactant | 1% | 1% | 1% | 1% | 1% |
| Organic Solvent | 3% | 3% | 3% | 3% | 3% |
| Water (q.s. to 100%) | | | | | |
| Averaged Reflectance R460 Value | 79.67 | 79.62 | 77.57 | 77.58 | 77.17 |

The averaged Reflectance R460 values of the treated fabric were about the same regardless the amount of sulfamic acid (wt %) in Tested Compositions #4A to #4E. Thus, the amount of sulfamic acid in the tested rust removal compositions had substantially no impact on the % rust removal of the stained fabric.

### Example 5

The rust removal efficacy and the fabric damage level for the use of different rust removal compositions on the rust stained fabric swatches as shown in EXAMPLES 1 and 3 were summarized in TABLE 5 below.

TABLE 5

Fabric Damage Level

| | Fluidity Value | % Change in |
|---|---|---|
| % Rust Removal | Poise⁻¹) | Fluidity Value |
| | N/A 9.0 N/A | |
| | 98% 13.0 44% | |

| | Rust Removal Efficacy |
|---|---|
| Rust Removal Composition | Reflectance |
| Reference 81 | R460 Value |
| [symbol] | 79 |
| [symbol] | |
| Tested Composition #1G or #3F | 77 |
| wt % oxalic acid, 3% ascorbic acid | |
| Tested Composition #1J | 75 |
| wt % oxalic acid, 3% ascorbic acid | |
| Tested Composition #3B | 46 |
| wt % oxalic acid, 0.5 wt % ascorbic acid) | |
| Tested Composition #3L | 41 |
| wt % oxalic acid, 7 wt % ascorbic acid | |

[symbol]

indicates data missing or illegible when filed

### Example 6

Rust stained fabric swatches were subjected to a two-step rust removal treatment, wherein the stained fabric swatches were contacted with the first composition for about 10 to 20 seconds, and then contacted with the second composition for 5 minutes.

TABLE 6 showed various first compositions used in the study, which contained different concentrations of ascorbic acid for rust removal, along with sodium bisulfite, sorbitol, surfactant, isopropyl alcohol as an organic solvent, and the balance of water. Tested Composition #6A contained no ascorbic acid. Tested Compositions #6B to #6K contained ascorbic acid in an amount ranging from about 0.5% by weight for Tested Composition #6B to about 6% by weight for Tested Composition #6K.

TABLE 6

| | Amount (% by weight based on total weight of the composition)* | | | | |
|---|---|---|---|---|---|
| Tested | Ascorbic | | Sodium | | Organic |
| Composition | Acid | Sorbitol | Bisulfite | Surfactant | Solvent |
| #6A | — | 3% | 3% | 1% | 5% |
| #6B | 0.5% | 3% | 3% | 1% | 5% |
| #6C | 1.0% | 3% | 3% | 1% | 5% |
| #6D | 1.5% | 3% | 3% | 1% | 5% |
| #6E | 2.0% | 3% | 3% | 1% | 5% |
| #6F | 2.5% | 3% | 3% | 1% | 5% |
| #6G | 3.0% | 3% | 3% | 1% | 5% |
| #6H | 4.0% | 3% | 3% | 1% | 5% |
| #6J | 5.0% | 3% | 3% | 1% | 5% |
| #6K | 6.0% | 3% | 3% | 1% | 5% |

*Balance of water to 100%

The second compositions used in the second step of treatment was an aqueous solution containing oxalic acid as an active ingredient for rust removal in an amount of 10% by weight based on total weight of the second compositions, along with monoethanol amine and the balance of water (“10% Oxalic Acid Solution”).

TABLE 7A showed the comparative % rust removal on the stained fabric swatches after the treatment with different rust removal compositions. Also reported was the averaged Reflectance R460 value of the fabric swatches that contained no rust stains and without any rust removal treatment (i.e. “Reference”).

Reference, which was the fabric swatches that contained no rust stains and without any rust removal treatment, showed the averaged Reflectance R460 value of 81±1. The higher the Reflectance R460 value indicated the higher level of the fabric whiteness, and thereby the superior efficacy of the rust removal composition in removing the rust from the stained fabric.

| | Rust Removal Composition | Reflectance | % Rust |
|---|---|---|---|
| Treatment No. | used in the Treatment | R460 Value | Removal |
| Reference | No Rust Removal Treatment | 81 ± 1 | N/A |
| | I 10% Hydrofluoric Acid Solution | 79 | [symbol] |
| | II 10% Oxalic Acid Solution | 38 | [symbol] |
| | III 1) Tested Composition #6A (0% Ascorbic Acid), and then | | |
| | 2) % Oxalic Acid Solution | | |
| | IV 1) Tested Composition #6B (0.5% Ascorbic Acid), and then | | |
| | 2) % Oxalic Acid Solution | | |
| | V 1) Tested Composition #6C (1% Ascorbic Acid), and then | | |
| | 2) % Oxalic Acid Solution | | |
| | VI 1) Tested Composition #6D (1.5% Ascorbic Acid), and then | | |
| | 2) % Oxalic Acid Solution | | |
| | VII 1) Tested, Composition #6E (2% Ascorbic Acid), and then | | |
| | 2) % Oxalic Acid Solution | | |
| | VIII 1) Tested, Composition #6F (2.5% Ascorbic Acid), and then | | |
| | 2) % Oxalic Acid Solution | | |
| | IX 1) Tested Composition #6G (3% Ascorbic Acid), and then | | |
| | 2) % Oxalic Acid Solution | | |
| | X 1) Tested Composition #6H (4% Ascorbic Acid), and then | | |
| | 2) % Oxalic Acid Solution | | |
| | XI 1) Tested Composition #6J (5% Ascorbic Acid), and then | | |
| | 2) % Oxalic Acid Solution | | |
| | XII 1) Tested Composition #6K (6% Ascorbic Acid), and then | 82 | 100 |
| | 2) % Oxalic Acid Solution | | |

[symbol]

indicates data missing or illegible when filed

Treatment No. I (the treatment with 10% Hydrofluoric Acid Solution) provided the averaged Reflectance R460 value of about 79, which corresponded to about 98% rust removal.

Treatment No. II (the treatment using 10% Oxalic Acid Solution alone) provided the averaged Reflectance R460 value of about 38, which corresponded to only about 47% rust removal.

Treatment No. III (the 2-step treatment using Tested Composition #6A that contained 0 wt % ascorbic acid, and then 10% Oxalic Acid Solution) provided the averaged Reflectance R460 value of 42, which corresponded to only about 51% rust removal. The Reflectance R460 values of Treatment Nos. II and III were about the same, since both treatments relied on oxalic acid as the sole active ingredient for rust removal and at the same concentration (10% by weight of oxalic acid).

Treatment Nos. IV to XII were the two-step treatment, wherein the first step was the treatment with the first composition containing ascorbic acid (i.e., Tested Compositions #6B to #6K, respectively), and then the second step was the treatment with the 10% Oxalic Acid Solution. As shown in TABLE 7A, Treatment Nos. IV to XII each showed a substantial enhancement in rust removal efficacy (% rust removal of about 100%), compared to Treatment No. II or III that relied on using oxalic acid as the sole active ingredient for rust removal (% rust removal of about 47% to about 51%).

TABLE 7B showed the fluidity values of the fabric swatches after treatment with the tested rust removal compositions.

TABLE 7B

| | | Fluidity | |
|---|---|---|---|
| | | Value of the | |
| | | Treated Fabric | % Change in |
| | Rust Removal | Swatches | Fluidity |
| Treatment No. | Composition | (Poise⁻¹) | Value |
| Reference | Rust stained fabric | 9.0 | N/A |
| | swatches without any | | |
| | rust removal treatment | | |
| I | 10% Hydrofluoric | 13.0 | 44% |
| | Acid Solution | | |
| II | 10% Oxalic | 11.5 | 28% |
| | Acid Solution | | |
| IV | 1) Tested | 11.2 | 24% |
| | Composition #6B (0.5% | | |
| | Ascorbic Acid), and then | | |
| | 2) 10% Oxalic | | |
| | Acid Solution | | |
| XII | 1) Tested | 11.7 | 30% |
| | Composition #6K (6% | | |
| | Ascorbic Acid), and then | | |
| | 2) 10% Oxalic | | |
| | Acid Solution | | |

As shown in TABLE 7B, upon using the conventional 10% Hydrofluoric Acid Solution as the rust removal composition (Treatment No. I), the treated fabric swatches showed about 44% lost in fluidity value. Upon using the 10% Oxalic Acid Solution as the rust removal composition (Treatment No. II), the treated fabric swatches showed about 28% lost in fluidity value. Treatment No. IV (the 2-step treatment using Tested Composition #6B that contained 0.5 wt % ascorbic acid, and then 10% Oxalic Acid Solution) provided the lost in fluidity value of 24%. Treatment No. XII (the 2-step treatment using Tested Composition #6K that contained 6 wt % ascorbic acid, and then 10% Oxalic Acid Solution) provided the lost in fluidity value of 30%.

Various features and advantages of the invention are set forth in the following claims.

1. A synergistic rust stain removal composition for fabric, comprising:
an oxalic acid in an amount of more than about 1% by weight but less than about 13% by weight based on total weight of the composition;
an ascorbic acid in an amount of more than about 0.5% but less than 7% by weight based on total weight of the composition; and
water.

2. The composition of claim 1, wherein the oxalic acid is present in an amount of more than about 6% but less than about 13% by weight based on total weight of the composition.

3. The composition of claim 1, wherein the oxalic acid is present in an amount of from about 2% to about 12% by weight based on total weight of the composition.

4. The composition of claim 1, wherein the oxalic acid is present in an amount of from about 3% to about 12% by weight based on total weight of the composition.

5. The composition of claim 1, wherein the oxalic acid is present in an amount of from about 7% to about 12% by weight based on total weight of the composition.

6. The composition according to claim 1, wherein the ascorbic acid is present in an amount of from about 1% to about 6% by weight based on total weight of the composition.

7. The composition according to claim 1, wherein the composition further comprises pH adjusting agent, organic solvent, surfactant, chelating agent, acrylic polymer, oxidizing agent, fragrance, dye, or any combination thereof.

8. The composition of claim 7, wherein the composition fulfills at least one of the following:
(a) the pH adjusting agent comprises sulfamic acid, ethanolamine, sodium bisulfite, or any mixture thereof;
(b) the organic solvent comprises glycol ether, alcohol, ethylene glycol, or a mixture thereof;
(c) the surfactant comprises anionic surfactant, non-ionic surfactant, or any combination thereof.

9. The composition of claim 8, wherein the anionic surfactant comprises sodium lauryl sulfate, sodium alkyl benzene sulfonate, or a mixture thereof.

10. The composition according to claim 1, wherein the composition consists of:
the oxalic acid in an amount of more than about 1% by weight but less than about 13% by weight based on total weight of the composition;
the ascorbic acid in an amount of more than about 0.5% but less than about 7% by weight based on total weight of the composition;
water; and
optionally at least one additive selected from the pH adjusting agent, the organic solvent, the surfactant, the chelating agent, the acrylic polymer, the oxidizing agent, the fragrance, the dye, or any combination thereof.

11. The composition of claim 10, wherein the oxalic acid is present in an amount of from about 2% to about 12% by weight based on total weight of the composition.

12. The composition of claim 10, wherein the ascorbic acid is present in an amount of from about 2% to about 6% by weight based on total weight of the composition.

13. The composition according to claim 1, wherein the composition does not comprise hydrogen peroxide, inorganic acid, other organic acid beside oxalic acid and ascorbic acid, fluorine-based salt, or any combination thereof.

14. The composition of claim 13, wherein:
(a) the inorganic acid comprises hydrofluoric acid, hydrochloric acid, sulfuric acid, nitric acid, phosphoric acid, boric acid, or any combination thereof;
(b) the other organic acid comprises formic acid, acetic acid, fumaric acid, citric acid, malic acid, tartaric acid, ethane-1-hydroxy-1,1′-diphosphonic acid, fatty acid, or any combination thereof; or
(c) the fluorine-based salt comprises calcium fluoride, sodium fluoride, ammonium bifluoride; or any combination thereof.

15. A method of removing rust stain from fabric, comprising contacting the fabric with the rust removal composition according to claim 1.

16. The method of claim 15, wherein the contact time is from about 1 minute to about 20 minutes.

17. A method of removing rust stain from fabric, comprising:
contacting the fabric with a first aqueous solution comprising from about 0.5% to about 6% by weight of ascorbic acid based on total weight of the first aqueous solution; and
contacting the fabric with a second aqueous solution comprising from about 1% to about 12% by weight of oxalic acid based on total weight of the second aqueous solution.

18. (canceled)

19. (canceled)

20. (canceled)

21. (canceled)

22. The method-according to claim 17,
wherein the method fulfills at least one of the following:
(a) the first aqueous solution comprises the ascorbic acid in an amount of from about 0.5%, about 1.0%, about 1.5%, about 2%, about 2.5%, about 3% or about 3.5% by weight based on total weight of the first aqueous solution to about 4%, about 4.5%, about 5.0%, about 5.5%, or about 6.0% by weight based on total weight of the first aqueous solution;
(b) the second aqueous solution comprises the oxalic acid in an amount of from about 1%, about 2%, about 3%, about 4%, about 5%, about 6% or about 7% by weight based on total weight of the second aqueous solution to about 8%, about 9%, about 10%, about 11% or about 12% by weight based on total weight of the second aqueous solution.

23. The method-according to claim 17, wherein the method provides the percentage of rust removal of at least 50% as calculated based on the reflectance of the fabric at a wavelength of 460 nanometers.

24. The method-according to claim 17, wherein the change in fluidity values of the fabric between before and after the contact with the rust removal composition is no more than 25% as determined according to the Indian Standard IS 244 (1984) (Second Revision, Reaffirmed 2006).

25. (canceled)
